(19) United States
(12) Patent Application Publication
(10) Pub. No.: US 2012/0090321 A1
(43) Pub. Date: Apr. 19, 2012

(54) Exhaust gas heat utilization in motor vehicles

(76) Inventors: Jan Gärtner, Leonberg (DE); Thomas Koch, Boblingen (DE)

(21) Appl. No.: 13/373,279

(22) Filed: Nov. 9, 2011

Related U.S. Application Data
(63) Continuation-in-part of application No. PCT/EP2010/001834, filed on Mar. 24, 2010.

(30) Foreign Application Priority Data
May 9, 2009 (DE) 10 2009 020 615.9

(51) Int. Cl. F02G 5/02

(52) U.S. Cl. 60/615; 60/616

(57) ABSTRACT

In an exhaust gas heat utilization device of a motor vehicle, comprising an exhaust gas heat utilization cycle in which an operating temperature of an operating fluid of the exhaust gas heat utilization cycle is controlled by adapting a mass flow of the operating fluid through a heat exchanger of the exhaust gas heat utilization cycle in such a way that a maximum permissible operating temperature, in particular the decomposition temperature, of the operating fluid is not exceeded.

This is a Continuation-In-Part application of pending international patent application PCT/EP2010/001834 filed Mar. 24, 2010 and claiming the priority of German patent application 10 2009 020 615.9 filed. May 9, 2009

### BACKGROUND OF THE INVENTION

The present invention relates to a method for operating an exhaust gas heat utilization cycle in a motor vehicle by controlling the operating temperature of an operating fluid. The invention further relates to an exhaust gas heat utilization device of a motor vehicle using the method and also to a fluid for use as an operating fluid in an exhaust gas heat utilization device.

DE 10 2007 057 164 A1 describes a system with an organic Rankine cycle system for cooling an internal combustion engine including an exhaust gas heat exchanger heating a pressurized operating medium for driving an expander and a method for operating the expander. In a Rankine cycle system according to US 2006 0 201 153 A1, water acting as an operating fluid of the Rankine cycle system is vaporized by the waste heat of the exhaust gas in an evaporator through which exhaust gas passes. In this process, the temperature of the steam emerging from the evaporator is measured, and the water quantity fed to the evaporator is controlled by means of this temperature.

In a Rankine cycle system according to DE 20 2007 002 602 U1, which uses an organic compound such as methyl cyclohexane or even octane or heptane as an operating fluid, the organic operating fluid is evaporated by the heat of the exhaust gas. For safety-relevant monitoring, a safe temperature limiter, which switches the system into a safe state by means of a switching signal if a temperature threshold is exceeded, is provided on the exhaust gas discharge side of the evaporator. As a result, there is no need for further safety equipment, such as flow monitoring devices in the operating fluid circuit of the Rankine cycle system. In this context, a low vapor temperature signals an operating medium-flooded evaporator.

EP 1 431 523 A1 describes a temperature control device for an evaporator, wherein the evaporator may be a part of a Rankine cycle system, by means of which an exhaust gas heat of an internal combustion engine can be utilized. As an operating fluid, water is evaporated in the heat exchanger of the Rankine cycle system by the waste heat of the exhaust gas. The vapor temperature is adjusted by means of the temperature control device by controlling the amount of water fed into the evaporator on the basis of the flow rate of the exhaust gas, the temperature of the exhaust gas, the temperature of the water and the vapor temperature.

Rankine cycle systems can be operated with organic or inorganic media. Rankine cycle systems using an organic operating fluid are also known as Organic RC or ORC. The name Clausius Rankine cycle systems or CRC is often used for Rankine cycles operated with organic media.

The organic Rankine cycle system uses an organic operating fluid which has the disadvantage that the thermal stability of the organic operating fluid is limited to comparatively low temperatures, that is, it vaporizes at relatively low temperature.

The present invention is based on the problem of specifying, for an operating method and/or an exhaust gas heat utilization device and/or an operating fluid, an improved embodiment which is in particular characterized in that the thermal stability of the operating fluid is taken into account to a greater degree for increased efficiency.

### SUMMARY OF THE INVENTION

In an exhaust gas heat utilization device of a motor vehicle, comprising an exhaust gas heat utilization cycle in which an operating temperature of an operating fluid of the exhaust gas heat utilization cycle is controlled by adapting a mass flow of the operating fluid through a heat exchanger of the exhaust gas heat utilization cycle in such a way that a maximum permissible operating temperature, in particular a decomposition temperature, of the operating fluid is not exceeded.

The invention is based on the general concept of controlling the operating temperature of the operating fluid of an exhaust gas heat utilization cycle by controlling the mass flow of the operating fluid flowing through the heat exchanger of the exhaust gas heat utilization cycle. This control of the operating temperature is intended to avoid that the operating fluid exceeds a maximum permissible operating temperature of an organic operating fluid used in the exhaust gas utilization cycle because of the high efficiency of such an operating fluid.

If organic operating fluids in particular are used, the exhaust gas temperature can significantly exceed the chemical decomposition temperature of the operating fluid. It is therefore expedient to set the maximum permissible operating temperature of the operating fluid slightly below the chemical decomposition temperature. The process temperature of the operating fluid should preferably remain below the decomposition temperature by the tolerance range of the temperature control quality. In this way, decomposition of the in particular organic operating fluid can be avoided or at least reduced or delayed.

In an operating fluid which is a mixture, the decomposition temperature is preferably the lowest of the chemical decomposition temperatures of the components of the operating fluid. This is hereinafter referred to as the lowest chemical decomposition temperature of the operating fluid.

Exhaust gas heat utilization cycles which are equipped with in particular organic operating fluids and which are operated such that the operating temperature is controlled by adapting a mass flow of the operating fluid flowing through the heat exchanger of the exhaust gas heat utilization cycle can be used in exhaust gas heat utilization devices of a motor vehicle.

An organic fluid can be used as operating fluid in such an exhaust gas heat utilization device of a motor vehicle in connection with an exhaust gas heat utilization cycle. The fluid, which can be vaporized and condensed, is an organic compound or a mixture of organic compounds and includes at least methanol, ethanol, N-propanol, isopropanol, dimethyl ether, ethylmethyl ether or an alkane. With tye use of at least one of the organic compounds or compound mixtures, which contains at least methanol, has a higher efficiency than a system which uses water as operating fluid.

Exhaust gas heat utilization systems can utilize the heat of the exhaust gases in the exhaust system and/or the heat of the recirculated exhaust gases.

The invention will become more readily apparent from the following description with reference to the accompanying drawings. Particular embodiments of the invention are shown in the drawings and explained in greater detail in the following description, identical reference numbers referring to identical or similar components or to components of identical function.

### BRIEF DESCRIPTION OF THE DRAWINGS

FIG. 1 shows an exhaust gas heat utilization device coupled to the exhaust gas flow of an internal combustion engine via a heat exchanger, and

FIG. 2 shows the efficiency curves of different operating fluids.

### DESCRIPTION OF A PARTICULAR EMBODIMENT

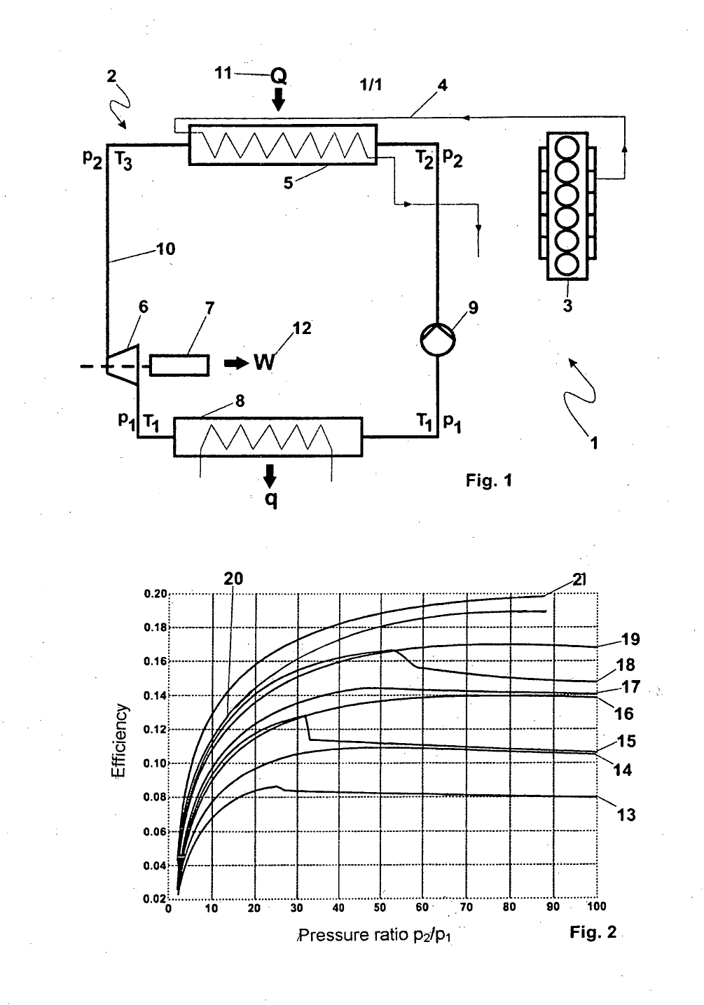

As shown in FIG. 1, an exhaust gas heat utilization device 1 for use in motor vehicles comprises an exhaust gas heat utilization cycle 2 and an internal combustion engine 3, which are connected to each other via an exhaust gas supply line 4. The exhaust gas heat utilization cycle 2, which is in this embodiment in the form of a Clausius Rankine cycle, comprises a heat exchanger 5, a turbine 6 with a power converter 7, a condenser 8 and a pump 9. If such an exhaust gas heat utilization cycle 2 is operated using a method according to the Clausius Rankine cycle, the operating fluid has a pressure p₁and a temperature T₁ in the circuit between the condenser 8 and the pump 9, a pressure p₂ and a temperature T₂ between the pump 9 and the heat exchanger 5, the pressure p₂ and a temperature T₃ between the heat exchanger 5 and the turbine 6 and the pressure p₁ and the temperature T₁ between the turbine 6 and the condenser 8. The pressure p₂ is higher than the pressure p₁ and the temperature T₃ is higher than the temperature T₂ and also higher than the temperature T₁. The exhaust gas heat utilization cycle can also be operated in another cycle, such as the Carnot cycle, the Stirling cycle, the Joule cycle or the like. In this case, there may be different pressure and temperature conditions in the operating fluid.

Hot exhaust gas generated by the internal combustion engine 3 is supplied to the heat exchanger 5 via the exhaust gas supply line 4. It flows through the heat exchanger 5 where it vaporizes the operating fluid circulating in a circulation line 10. The operating fluid is expanded in a turbine 6, whereby a part of the waste heat 11 supplied to the heat exchanger 5 can be converted into useful work by the power converter 7. The expanded operating fluid is then liquefied in the condenser 8 and the liquid is pressurized by the pump 9 and pumped at an increased pressure p₂ through the heat exchanger 5 to absorb waste heat 11.

In the embodiment described herein, the exhaust gas heat utilization cycle 2 can be operated by means of a method in which the operating temperature of the operating fluid can be controlled by adapting a mass flow of the operating fluid through the heat exchanger 5 in such a way that a maximum permissible operating temperature of the operating fluid is not exceeded. In organic operating fluids such as methanol, diethyl ether, dimethyl ether or the like, or in mixtures of organic compounds in particular, an accurate control of the operating temperature T₁, T₂ of the operating fluid is essential for a proper functioning of the exhaust gas heat utilization cycle 2, as the temperature of the hot exhaust gases may reach 700° C. and, consequently, substantially exceeds the decomposition temperature of the operating fluid of e.g. 350° C. In this case, the hot exhaust gas flowing through the heat exchanger 5 would at full load at least partially decompose the organic operating fluid flowing through the heat exchanger 5 in the opposite direction. As this is to be avoided, it is expedient to choose the maximum permissible operating temperature of the operating fluid such that it is for example at least 20° C. below the chemical decomposition temperature of the operating fluid.

In the case of mixed materials, it has to be kept in mind that the individual organic compounds decompose at different temperatures. In this case, the maximum permissible operating temperature has to be chosen such that the lowest chemical decomposition temperature is taken into account. In this context, it is expedient to choose an operating fluid with a chemical decomposition temperature t which lies above the tolerance range of temperature control quality, for example 20° C. above the maximum temperature of the waste heat fluid. In this case the chemical decomposition of the operating fluid by the waste heat fluid can be ignored or at least becomes relevant only if the flow of the operating fluid through the heat exchanger 5 is slowed or interrupted for example by a technical defect and the operating fluid in the heat exchanger 5 remains stagnant in the heat exchanger 5.

The operating temperature of the operating fluid can in addition be controlled by cooling the operating fluid before it enters the heat exchanger 5. The operating temperature can further be influenced by limiting the mass flow of waste heat fluid through the heat exchanger 5 or by adding cold fluids to the waste heat fluid before it enters the heat exchanger 5. Such measures are advantageous if a maximum possible mass flow of operating fluid has been reached in the circulation line 10 and cannot be increased further. If in this case the temperature nevertheless increases downstream of the heat exchanger 5 towards the turbine 6, and if there is a risk that the maximum permissible operating temperature of the operating fluid might be exceeded, the waste heat 11 which is transferred to the operating fluid from the waste heat fluid in the heat exchanger 5 can be limited, thereby controlling the operating temperature of the operating fluid.

For a more precise and finer adjustment of the operating temperature of the operating fluid, further parameters can be taken into account when controlling the operating temperature. By means of detecting and processing the temperature of the waste heat fluid upstream and/or downstream of the heat exchanger 5 and/or the temperature of the operating fluid upstream and/or downstream of the heat exchanger 5 as well as a pressure of the operating fluid upstream and/or downstream of the turbine 6 and/or a flow velocity of the operating fluid and/or of the waste heat fluid, the waste heat 11 transferred in the heat exchanger 5 can be determined from the detection signals, in particular in a time-dependent manner, so that the temperature of the operating fluid can be held constantly below the chemical decomposition temperature also during peak loads.

It is advantageous to use as operating fluids in a waste heat utilization device 1 such organic compounds which provide for a higher efficiency of the waste heat utilization device 1 than water would. A good example, as shown in FIG. 2, is methanol. According to FIG. 2, several efficiency curves of n-octane 13, n-heptane 14, toluol 15, n-hexane 16, cyclohexane 17, benzene 18 and ethanol 19 indicate a lower efficiency than the efficiency curve of water 20. In these examples, only the efficiency curve of methanol 21 indicates a higher efficiency than water 20. Alkanes are also suitable operating fluids. In this context, it should however be pointed out that other organic compounds, if used as operating fluids, may offer a still higher efficiency in the waste heat utilization device 1. In an advantageous embodiment, an organic operating fluid is therefore used which comprises an organic compound or a mixture of organic compounds, this operating fluid having a higher efficiency in the exhaust gas heat utilization device 1 than water 20.

A change in the mass flow of the operating fluid changes the temperature T₃ of the operating fluid. An increase in the mass flow reduces the heat input per mass unit and lowers the operating fluid temperature T₃. A reduction in the mass flow can increase the heat input per mass unit and thereby the operating fluid temperature T₃. In this way, the operating temperature T₃ can be controlled by adaptation of the mass flow of operating fluid.

The decomposition temperature of such an operating fluid can be taken into account by controlling the operating temperature by controlling the mass flow of the operating fluid in such a way that the operating temperature always remains below the decomposition temperature of the operating fluid during the operation of the exhaust gas heat utilization device.

### LIST OF REFERENCE NUMBERS

1 Exhaust gas heat utilization device
2 Exhaust gas heat utilization cycle
3 Internal combustion engine
4 Exhaust gas supply line
5 Heat exchanger
6 Turbine
7 Power converter
8 Condenser
9 Pump
10 Circulation line
11 Waste heat
12 Work
13 n-octane
14 n-heptane
15 Toluol
16 n-hexane
17 Cyclohexane
18 Benzene
19 Ethanol
20 Water
21 Methanol

What is claimed is:

1. A method for operating an exhaust gas heat utilization cycle (2) in a motor vehicle, the exhaust gas heat utilization cycle including a pump (9) for pressurizing an operating fluid, a heat exchanger (5) for transferring waste heat of a motor (3) of the motor vehicle to the pressurized operating fluid so as to vaporize the operating fluid, an expander (6) for recuperating mechanical energy by expansion of the pressurized operating fluid and a condenser (5) for condensing the expanded operating fluid,
the method comprising the step of: controlling an operating temperature (T₁, T₂, T₃) of the operating fluid by adapting a mass flow of the operating fluid through the heat exchanger (5) of the exhaust gas heat utilization cycle (2) in such a way that a maximum permissible operating temperature of the operating fluid is not exceeded.

2. The method according to claim 1, wherein
The operating temperature (T₁, T₂, T₃) of the operating fluid is controlled in addition by at least one of the following measures:
cooling of the exhaust gas of the internal combustion engine (3), before it enters the heat exchanger (5),
limiting of the mass flow of waste heat fluid through the heat exchanger (5), and
adding cold fluids to the waste heat fluid before it enters the heat exchanger (5).

3. The method according to claim 1, wherein, in controlling the operating temperature (T₁, T₂, T₃), at least one of the following parameters is taken into account:
a temperature of the waste heat fluid upstream of the heat exchanger (5),
a temperature of the waste heat fluid downstream of the heat exchanger (5),
a temperature (T₂) of the operating fluid upstream of the heat exchanger (5),
a temperature (T₃) of the operating fluid downstream of the heat exchanger (5),
a pressure (p₂) of the operating fluid upstream of a turbine of the exhaust gas heat utilization cycle (2),
a pressure (p₁) of the operating fluid downstream of the turbine of the exhaust gas heat utilization cycle (2),
a flow velocity of the operating fluid,
a flow velocity of the waste heat fluid.

4. The method according to claim 1, wherein the maximum permissible operating temperature of the operating fluid is below the chemical decomposition temperature of the operating fluid by a predetermined safety margin.

5. The method according to claim 4, wherein the maximum operating temperature of the operating fluid is below the chemical decomposition temperature at least by an error tolerance range of the temperature control arrangement.

6. The method according to claim 1, wherein the method comprises a cycle in the form of one of a Carnot cycle, Clausius Rankine cycle, Stirling cycle and a Joule cycle.

7. An exhaust gas heat utilization device of a motor vehicle, comprising an exhaust gas heat utilization cycle (2) which is designed such that it can be operated using a method according to claim 1.

8. A fluid for use as an operating fluid in an exhaust gas heat utilization device (1), according to claim 7, of a motor vehicle, comprising an exhaust gas heat utilization cycle (2), wherein the fluid can be vaporized and condensed and contains, or is, an organic compound or a mixture of organic compounds, the fluid comprising at least one of the following compounds:
a simple alcohol such as a methanol, ethanol n-propanol, isopropanol,
an ether such as dimethyl ether, ethylmethyl ether, diethyl ether,
an alkane.

9. The fluid according to claim 8, wherein the lowest chemical decomposition temperature of the operating fluid exceeds a maximum temperature of the waste heat fluid by the control range of temperature quality.
